(19) United States
(12) Patent Application Publication
(10) Pub. No.: US 2006/0245730 A1
(43) Pub. Date: Nov. 2, 2006

(54) [IDENTIFIER RECORDER FOR IDENTIFYING PICTURE IDENTIFICATION CODE]

(75) Inventor: Wen-Hsin Fang, TAIPEI (TW)

Correspondence Address: ULTMOST INDUSTRIAL CORP., P.O. BOX 108-00403, TAIPEI, TW

(73) Assignee: ULTMOST INDUSTRIAL CORP., Hsin Tien, Taipei. (TW)

(21) Appl. No.: 10/908,148

(22) Filed: Apr. 28, 2005

(51) Int. Cl. H04N 5/91

(52) U.S. Cl. 386/96

(57) ABSTRACT

An identifier recorder suitable for identifying picture identification code includes a microprocessor electrically connected to a button set for controlling recording and playing, a reader for sensing and identifying the picture identification code, a recording device for recording and a storage device for storing data of the picture. The storage device may be electrically connected to an audio source device for playing the audio signal, and the identifier recorder may be adopted for identifying the picture identification code by identifying the picture punch, or for identifying the bar code by using a bar code pen scanner or an irradiative probe, so that it is not necessary to buy an external bar code identifier recorder. The identifier recorder is portable and can be conveniently used at any place. Thus, the consumer's purchase intention may be enhanced.

### BACKGROUND OF THE INVENTION

1. Field of the Invention

The present invention relates to an identifier recorder suitable for identifying a picture code. More particularly, the present invention relates to an identifier recorder suitable for identifying picture code applicable in pen scanner and irradiative probe for identifying bar code, or irradiative optical sensor reader for sensing picture punch. The user may record different sound data corresponding to different pictures. As the bar code is provided for identifying the picture, it is not necessary to buy an external bar code identifier recorder. Therefore, the present invention is easy to implement and can be conveniently used at any place. Thus, the identifier recorder of the present invention could be attractive to consumers.

2. Description of Related Art

In recent years, the rapidly developing electronic technology provides greater convenience to human beings and save time. For example, camera was popular in the early days, however, conventional camera has been gradually replaced by digital video (DV). The electronic products, such as camera or DV, are convenient for recording everyday activity and the recording can be stored as wonderful memory. However, to replay the image data stored in the DV, high technology electronic products such as computer or notebook are required, so that the cost of such entertainment is high and the process is complex. The image data recorded by the DV is a motion picture, therefore, a DV player and television are required for playing the image data, and it is not convenient to convert the image data into pictures for the user to browse. Alternatively, the camera is suitable for capturing wonderful images for the user at any time, and the captured images may be well-developed into pictures, so that the pictures may be browsed by the user at any time and any place. In general, the camera is more convenient than the DV. However, the image captured by the camera is static picture, but the image data recorded by DV is motion picture. Thus, the DV is more convenient for recording the whole event.

Therefore, to overcome the disadvantages of conventional camera and DV, a touch recordable and playable picture frame is developed by the manufacturers in the field. Referring to FIGS. 4 and 5, the frame A includes a receiving space A1 for placing the picture, in which the frame A includes a circuit board B. The circuit board B has an audio processor B1, a DRAM (dynamic random access memory) B2, a recorder B3, an amplifier B4, a speaker B5 and a touch switch B6, and a record button A2 extended from the circuit board B. As the record button A2 is pressed, sound is recorded by the recorder B3 and then input to the audio processor B1, then the audio processor B1 converts the sound into digital signal and the digital signal is stored in the DRAM (dynamic random access memory) B2. When the user touches the touch switch B6, the replay function of sound is activated, and thus the digital signal stored in the DRAM (dynamic random access memory) B2 is converted into analog signal, and then the analog signal is amplified by the amplifier B4 and output by the speaker B5.

However, the conventional touch recordable and playable picture frame described above has several disadvantages as described below.

1. The conventional touch recordable and playable picture frame can only store a picture and audio single data corresponding to the picture. Thus, when the user has more than one pictures and sounds to be stored, the user has to buy more than one picture frames, thus the cost is very high.

2. The audio single data recorded by the conventional touch recordable and playable picture frame cannot be changed with the corresponding picture. In other words, as the user changes the picture, the audio single data has to be recorded again. Thus, the conventional touch recordable and playable picture frame is not convenient and thus unattractive to consumers.

Furthermore, in order to resolve the disadvantages of the conventional touch recordable and playable picture frame described above, some manufacturers developed a picture management device with recording and playing functions. Referring to FIGS. 6 and 7, the picture management device has an identification device E for reading an identification code G1 of a picture G, and then the identification code G1 is transmitted to a microprocessor C. The microprocessor C may find the corresponding storage location of the identification code G1 in a record and play storage chip D, and then the audio signal stored at the storage location is output by an audio source device F. Or, the audio signal data received by the audio source device F may be stored to the storage location, so that the recorded sound data may be changed with the corresponding picture G. As described above, although the disadvantages of the conventional touch recordable and playable picture frame are improved, but the picture can only be placed in the picture frame that can read the identification code. The picture frame is not portable and therefore not convenient, and can be easily damaged. If the picture frame is damaged, the consumer has to buy a new picture frame for replacing the damaged picture frame, thus the cost is high. Therefore, the prior arts described above still have several problems and it is highly desirable to resolve these problems.

Accordingly, it is important to solve the problems and the disadvantages of the prior arts described above for the manufacturers of the related field.

### SUMMARY OF THE INVENTION

Accordingly, in the view of the foregoing, the present inventor makes a detailed study of related art to evaluate and consider, and uses years of accumulated experience in this field, and through several experiments, to create a new identifier recorder for identifying a picture code, which is easy to implement and convenient to use at any place. Thus, the identifier recorder of the present invention could be attractive to consumers.

According to an aspect of the present invention, a code identification circuit is provided. By applying the identifier recorder to read the picture identification code and transmitting the identification code to the microprocessor, the microprocessor may determine the corresponding storage location of the identification code in the storage device. Then, the audio signal stored at the storage location may be played by the audio source device, or the audio signal received by the audio source device may be stored to the storage location, so that the recorded sound data may be changed with the corresponding picture. Therefore, the user may record different sound data corresponding to different pictures, and the identifier recorder may be disposed within, for example, a pen scanner or an irradiative probe for identifying bar code, or an irradiative optical sensor reader for sensing picture punch. In one embodiment of the present invention, as the bar code is provided for identifying the picture, it is not necessary to buy an external bar code identifier recorder. Therefore, the present invention is easy to implement and can be conveniently used at any place. Thus, the identifier recorder of the present invention could be attractive to consumers.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic block diagram of one embodiment of the present invention.

FIG. 2 is a flowchart illustrating a procedure of recording a black audio signal picture according to one embodiment of the present invention.

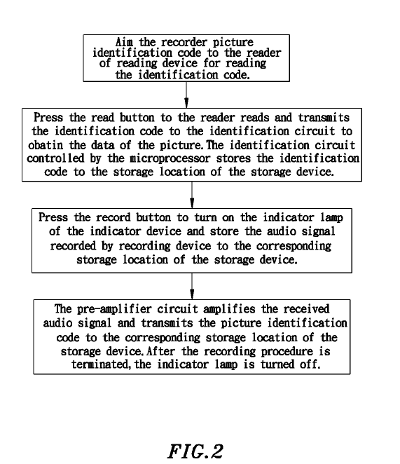

FIG. 3 is a flowchart illustrating a procedure of playing a recorded audio signal picture according to one embodiment of the present invention.

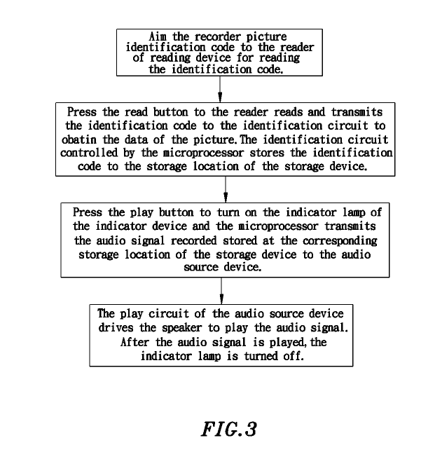

FIG. 4 is an elevational view of a conventional picture frame.

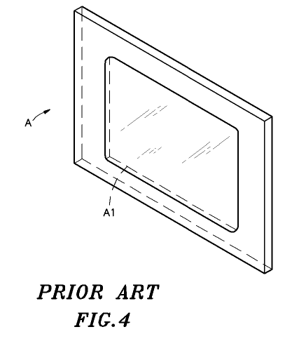

FIG. 5 is a block diagram of a conventional picture frame.

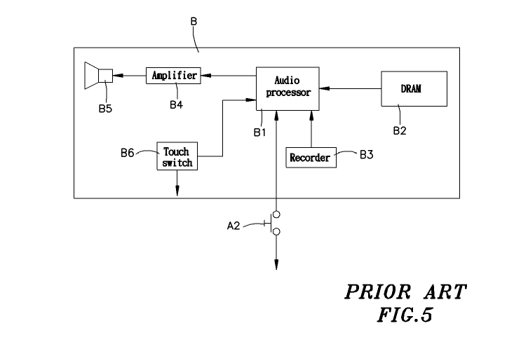

FIG. 6 is a schematic block diagram of a conventional picture management device with recording and playing functions.

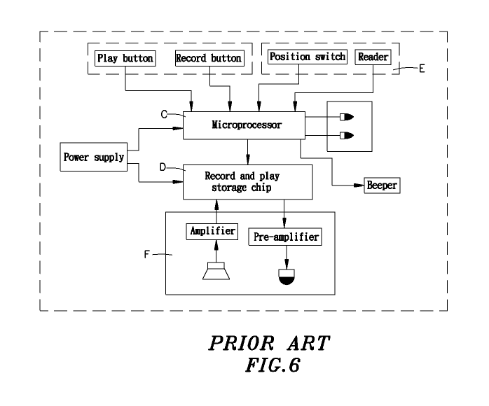

FIG. 7 is an elevational view of a conventional picture management device with recording and playing functions.

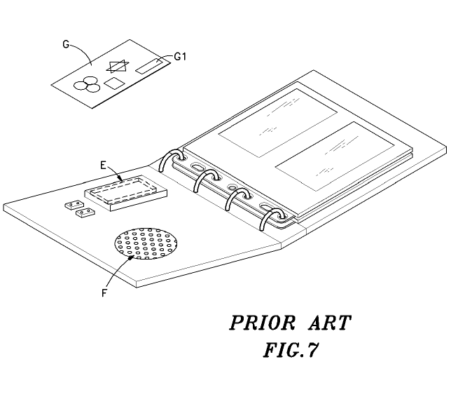

### DESCRIPTION OF PREFERRED EMBODIMENTS

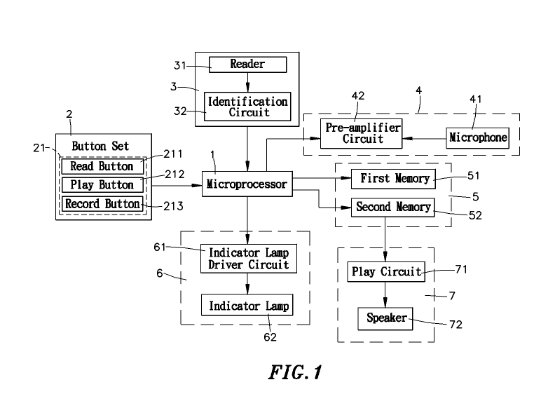

Referring to FIG. 1˜3, an identifier recorder for identifying picture identification code in accordance with one embodiment of the present invention is shown comprised of a microprocessor 1. The microprocessor 1 is connected to a button set 2, a reading device 3, a recording device 4, a storage device 5 and an indicator device 6.

The microprocessor 1 is adopted for controlling the recording device 4 for recording and storing the audio signal received by the recording device 4 at the corresponding storage location of the storage device 5 according to the identification code read by the reading device 3.

The button set 2 comprises a plurality of buttons 21 electrically connected to the microprocessor 1. The buttons 21 include a read button 211, a play button 212 and a record button 213.

The reading device 3 comprises a reader 31 for reading the picture identification code. The reader 31 is electrically connected to an identification circuit 32 for identifying the identification code read by the reader 31.

The recording device 4 comprises a microphone 41 for receiving an audio signal. The microphone 41 is electrically connected to a pre-amplifier circuit 42 for amplifying the audio signal received by the microphone 41.

The storage device 5 comprises a first memory 51 and a second memory 52. The storage device 5 is electrically connected to an audio source device 7 for playing the audio signal stored in the storage device 5.

The indicator device 6 comprises an indicating lamp driver circuit 61. The indicator lamp driver circuit 61 is electrically connected to an indicator lamp 62.

The audio source device 7 comprises a player circuit 71. The player circuit 71 is electrically connected to a speaker 72.

Further, the reader 31 may comprise a pen scanner and an irradiative probe for identifying bar code, or an irradiative optical sensor reader for sensing picture punch.

When using the blank audio signal picture of the present invention to record sound, the recorded picture identification code is aimed to the reader 31 of the reading device 3 for reading the identification code. By pressing the read button 211, the reader 31 reads the identification code, and then the identification code is transmitted to the identification circuit 32 for identifying and to obtain the data of the picture. At this moment, the recorded sound data of the picture is played automatically according to the identification code, and the indicator lamp 62 of the indicating device 6 is turned on. If pressing the record button 213 and the read button 211 at the same time, the audio signal recorded by the recording device 4 is stored to the corresponding storage location of the storage device 5, and the pre-amplifier circuit 42 amplifies the received audio signal and transmits the identification code of the picture to the corresponding storage location of the storage device 5. After the audio signal is recorded, the indicator lamp 62 is turned off.

However, if the picture identification code received by the reader 31 of the reading device 3 is due to an error, a sound “di-di-di” may be sent out and the indicator lamp 62 is twinkles and flashes.

Further, the recording of the picture identification code may comprise, for example, a long-time recording and a short-time recording according to the definition of a designer. The short-time recording means that as the microprocessor 1 detects that the record button 213 is pressed, then the microprocessor 1 transmits the audio signal to the storage device 5 for storage. When the record button 213 is released, the recording procedure is terminated and the indicator lamp 612 is turned off. In addition, the recorded sound data may be replayed once automatically after recording. The long-time recording means that as the microprocessor 1 detects that the record button 213 is released immediately after being pressed, and then the microprocessor 1 transmits the audio signal to the storage device 5 for storage. The recording procedure is not terminated even when the record button 213 is released until the user presses the record button 213 once again. The microprocessor 1 will take out the audio signal stored in the storage device 5 and the audio signal is output by the speaker 72 via the audio source device 7. Besides, the identification code may comprise a bar code or an optoelectronic code hole.

When a recorded picture of the present invention is played, the recorded picture identification code is aimed to the reader 31 of the reading device 3 for reading the identification code. By pressing the read button 211, the reader 31 reads the identification code, then the identification code is transmitted to the identify circuit 32 for identifying and to obtain the data of the picture. At this moment, the microprocessor 1 may control the storage device 5 for playing the recorded data corresponding to the picture identification code. After the picture identification code is obtained, the play button 212 may be pressed repeatedly to play the same recorded data of the picture. As the sound data is played, the indicator lamp 62 of the indicating device 6 may be turned on to twinkle. The microprocessor 1 may transmit the audio signal stored at the corresponding storage location to the audio source device 7, and the player circuit 71 of the audio source device 7 drives the speaker 72 for playing the audio signal. After the sound data is played, the indicator lamp 62 is turned off.

As described above, by using the identifier recorder to read and transmit the picture identification code to the microprocessor, the microprocessor may determine the corresponding storage location of the identification code in the pre-amplifier circuit. Then the audio signal stored at the storage location may be played by the audio source device, or the audio signal received by the audio source device may be stored to the storage location, so that the recorded sound data may be changed with the corresponding picture. Therefore, the user may record different sound data corresponding to different picture, and the recorder may be disposed, for example, within portable electronic products such as pen scanner or an irradiative probe for identifying bar code, or irradiative optical sensor reader for sensing picture punch. As the bar code is provided for identifying the picture, it is not necessary to buy an external bar code identifier recorder. Therefore, the present invention is easy to implement and can be conveniently used at any place. Thus, the identifier recorder for identifying the picture identification code could be attractive to consumers.

A prototype of identifier recorder has been constructed with the feature of FIGS. 1˜3. The identifier recorder functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An identifier recorder suitable for identifying a picture identification code, comprising:
a reading device, comprising a reader for reading a picture identification code and electrically connected to an identification circuit for identifying an identification code read by the reader;
a recording device, comprising a microphone for receiving the audio signal, wherein the microphone is electrically connected to a pre-amplifier circuit for amplifying the audio signal received by the microphone; and
a storage device, for storing an audio signal received by the recording device; and
a microprocessor, electrically connected to the reading device, the recording device and the storage device, for controlling the recording device for recording and storing an audio signal recorded by the recording device to a corresponding storage location of the storage device according to a picture identification code read by the reading device.

2. The identifier recorder of claim 1, wherein the storage device is electrically connected to an audio source device for playing the audio signal stored in the storage device.

3. The identifier recorder of claim 2, wherein the audio source device comprises a player circuit electrically connected to a speaker.

4. The identifier recorder of claim 1, wherein the microprocessor is electrically connected to a button set, and the button set comprises a plurality of buttons.

5. The identifier recorder of claim 1, wherein the microprocessor is further electrically connected to an indicator device.

6. The identifier recorder of claim 5, wherein the indicator device comprises an indicator lamp driver circuit and the indicator lamp driver circuit is electrically connected to an indicator lamp.

7. The identifier recorder of claim 1, wherein the storage device comprises a first memory and a second memory.

8. The identifier recorder of claim 1, wherein the reader comprises a pen scanner and an irradiative probe for identifying a bar code, or an irradiative optical sensor reader for sensing picture punch.

9. The identifier recorder of claim 1, wherein the reader comprises a bar code scanner.

10. The identifier recorder of claim 1, wherein the identification code comprises a bar code.

11. The identifier recorder of claim 1, wherein the identification code comprises an optoelectronic code hole.
